(19) United States
(12) Patent Application Publication
(10) Pub. No.: US 2009/0211821 A1
(43) Pub. Date: Aug. 27, 2009

(54) CAPACITIVE STYLUS PEN

(75) Inventors: YU-CHOU YEH, Taoyuan Hsien (TW); KUO-YI YEN, Taoyuan Hsien (TW); YU-HONG YEN, Taoyuan Hsien (TW); YU-CHUNG HUANG, Taoyuan Hsien (TW); CHU-CHIA HUANG, Taoyuan Hsien (TW)

Correspondence Address: WPAT, PC, 7225 BEVERLY ST., ANNANDALE, VA, 22003, US

(73) Assignee: J TOUCH CORPORATION, Taoyuan Hsien (TW)

(21) Appl. No.: 12/101,936

(22) Filed: Apr. 11, 2008

(30) Foreign Application Priority Data
Feb. 25, 2008 (TW) 097106406

(51) Int. Cl. G06F 3/044

(52) U.S. Cl. 178/19.03

(57) ABSTRACT

This invention provides a capacitive stylus pen including a conductive plate, a joint and a conductive pen body is provided, wherein the joint is connected between the conductive plate and the conductive pen body such that the conductive pen body could move around the conductive plate. In another embodiment, a capacitive stylus pen includes a conductive pen body and a universal joint connected to the conductive pen body, wherein the universal joint has at least a quasi-flat surface such that the universal joint has both functions of the conductive plate and the joint mentioned above. Thus, the capacitive stylus pens mentioned above both provide convenience to use by position input.

### BACKGROUND of the invention

1. Field of the Invention

This invention generally relates to a capacitive stylus pen. More particularly, the invention relates to a capacitive stylus pen which is able to apply to a touch panel.

2. Description of the Related Art

Nowadays, many embedded system such as personal digital assistant (PDA), mobile phone, vehicle navigation system, and flat computer are generally used in human's life. Usually, one capacitive touch screen is equipped on the embedded system for input. User operates the system by their finger to touch the screen and the screen senses the voltage drop caused the finger to define the touched position.

When a test procedure of a capacitive touch panel is proceeding, the test object is usually a copper column. The copper column is directly touched on the capacitive touch panel to see if the touch panel could determine the touched position, wherein the cross-section square measure is about 100 mm². Besides, when the capacitive touch screen senses an area touched like a finger or a copper column, it could prevent interference of the other noise signal.

Makers of the capacitive touch screen usually design the screen by square measure of the fingers and the measure is generally defined as 8×8 mm². However, deformation effect is caused when a finger touches the capacitive touch screen such that the sensed area is less than 8×8 mm². The sensed area also depends on the different capacitive touch screen or different quantity of capacitors in the panel.

On the other hand, the touched area is too small to be sensed by a touch panel when the square measure of a capacitive stylus pen is less than 1×1 mm². Besides, the pen body usually has a fix angle with the pen point such that user must keep the angle to utilize the capacitive stylus pen on the touch screen.

It is understood that the disadvantage of conventional capacitive stylus pen is not convenient for user to input on the touch screen. Therefore, an improvement is needed to the conventional capacitive stylus pen.

### BRIEF SUMMARY OF THE INVENTION

To solve the disadvantage of the prior art. The present invention provides an improved capacitive stylus pen.

The primary aspect of the present invention is to provide a capacitive stylus pen, the pen could adjust the angle relative to the touch panel when it is used to input. The theorem is the movement of the electrons between human body and the touch panel and detection of the voltage of the capacitor is determined to decide the coordinate on the touch panel.

The second aspect of the present invention is to provide a capacitive stylus pen comprises at least one conductive plate; at least one joint being configured on the conductive plate; and a conductive pen body, wherein the joint is connected between the conductive plate and the conductive pen body such that the conductive pen body could move around the conductive plate. In addition, a universal joint is the combination of the conductive plate and the joint, the universal joint has a quasi-flat surface to stick on the touch panel.

In one embodiment, the quasi-flat surface of the universal joint being configured to stick on a touch panel flatly, the cross-section view of the quasi-flat surface of the universal joint is selected from the group consisting of a square, a circular form, a triangle form and a rhombus form and the square measure of the flat surface is larger than 1 mm².

In another embodiment, the conductive pen body is capable of having multiple dimensional motions on the universal joint to adjust an angle between the conductive pen and the touch panel.

In yet another embodiment, the joint is an universal joint, an universal drive joint, a flexible joint, or a cross joint.

A detailed description is given in the following embodiments with reference to the accompanying drawings.

### BRIEF DESCRIPTION OF the DRAWINGS

The invention can be more fully understood by reading the subsequent detailed description and examples with references made to the accompanying drawings, wherein:

FIG. 1A is a schematic diagram of a capacitive stylus pen according to an embodiment of the present invention;

FIG. 1B is a schematic diagram when a capacitive stylus pen being applied on a touch panel according to an embodiment of the present invention;

FIG. 2 is a schematic diagram of a capacitive stylus pen according to another embodiment of the present invention; and

FIG. 3 is a perspective view of a capacitive stylus pen according to an embodiment of the present invention.

### DETAILED DESCRIPTION OF THE INVENTION

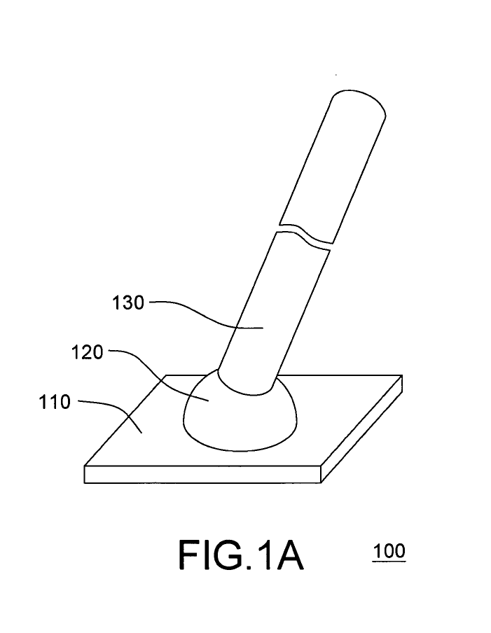

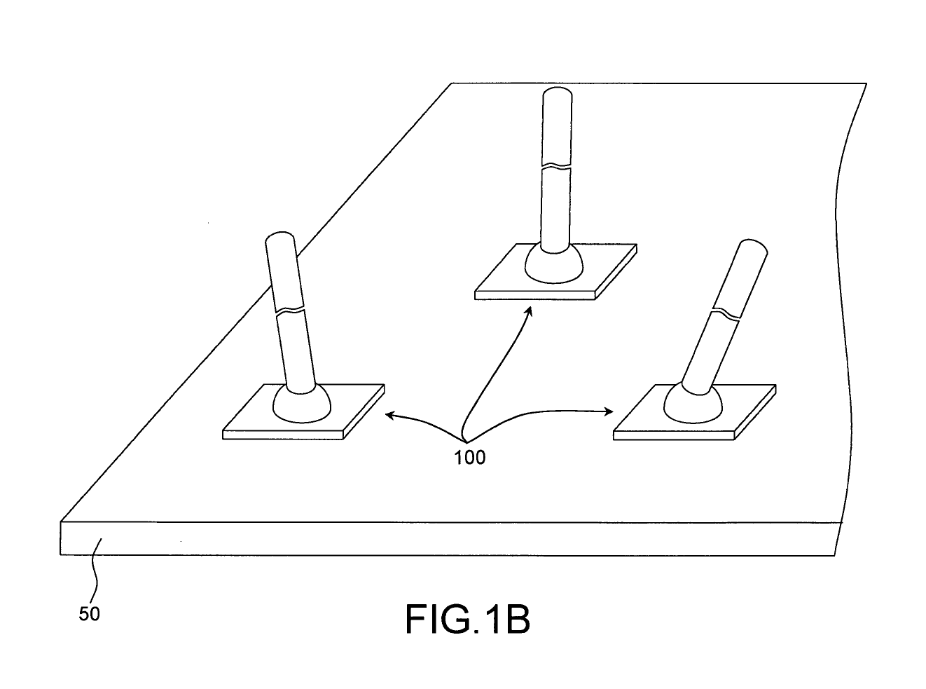

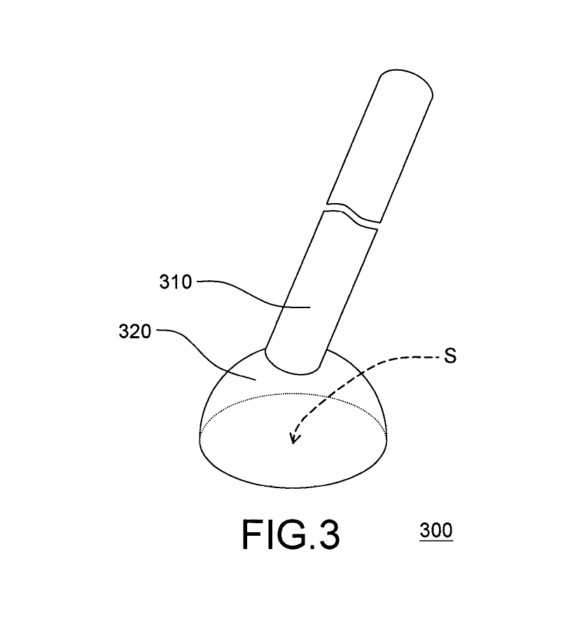

Several exemplary embodiments of the invention are described with reference to FIG. 1A˜FIG. 3, which generally relate to an apparatus for security of accessing data. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

Referring to FIGS. 1A and 1B, FIG. 1A is a schematic diagram of a capacitive stylus pen according to an embodiment of the present invention and FIG. 1B is a schematic diagram when a capacitive stylus pen being applied on a touch panel according to an embodiment of the present invention. In FIG. 1A, the capacitive stylus pen 100 includes a conductive plate 110, a joint 120 and a conductive pen body 130. The joint 120 is coupled between the conductive plate 110 and the conductive pen body 130, which makes electrical coupling between the conductive plate 110 and the conductive pen body 130. Users could hold the conductive pen body 130 to move on the touch pane 150 flatly. The touch panel 50 could sense micro voltage from the user to determine the position of the conductive pen 100 on the touch screen 50.

When the capacitive stylus pen 100 is located on different position of the touch panel 50, the angle between the conductive pen 130 and the touch panel 50 also changes. By the joint 120, it is connected between the conductive plate 110 and the conductive pen body 130 such that the conductive pen body 130 could move around the conductive plate 110 and the conductive plate 110 still flatly stick on the touch panel 50. It is convenient for user to changes the angle between the conductive pen body 130 and the touch panel 50, and to easily input.

In one embodiment, the joint 120, for example a universal joint, makes the conductive pen body 130 is capable of having multiple dimensional motion on the conductive plate 110 to adjust an angle between the conductive pen 130 and the touch panel 50. The joint 120 is, but not limited to the universal joint, for example a universal drive joint, a flexible joint, a cross joint or a combination thereof.

In addition, the material of surface of the joint 120 is, but not limited to, plastic or acrylic. The inner material of the joint 120 is a metal wire electrically coupled between the conductive plate 110 and the conductive pen body 130. Surely, the surface of the conductive pen body 130, the touch panel 50 and the conductive plate 110 is conductive material.

Besides, the universal joint 120 is strict to make the relative stable condition between the conductive pen body 130 and the conductive plate 110. When users impose external force on the conductive pen body 130, the angle is changed between the conductive pen body 130 and the conductive plate 110, and the stable condition between the conductive pen body 130 and the conductive plate 110 is kept when the external force is removed.

In another embodiment, the universal joint 120 has elasticity to keep vertical position between the universal joint 120 and the touch panel 50 when there is no external force involved. When users utilize the conductive stylus pen 100 again, the conductive plate 110 almost sticks flatly on the touch panel 50 to touch a need minimum area. The conductive pen body 130 is, but not limited to, a cylinder.

In FIGS. 1A and 1B, the conductive plate 110 has a minimum square measure which is related to a sense area of the touch panel 50. Generally speaking, the smaller square measure of the conductive plate 110 is the better for operation convenient. The square measure of the conductive plate 110 is designed about 25 mm² which is the minimum. Also, the shape of the conductive plate 110 is, but not limited to, a square, a circular form, a triangle form and a rhombus form. More particularly, the shape could be designed to be a cute shape like Hello Kitty or Doraemon.

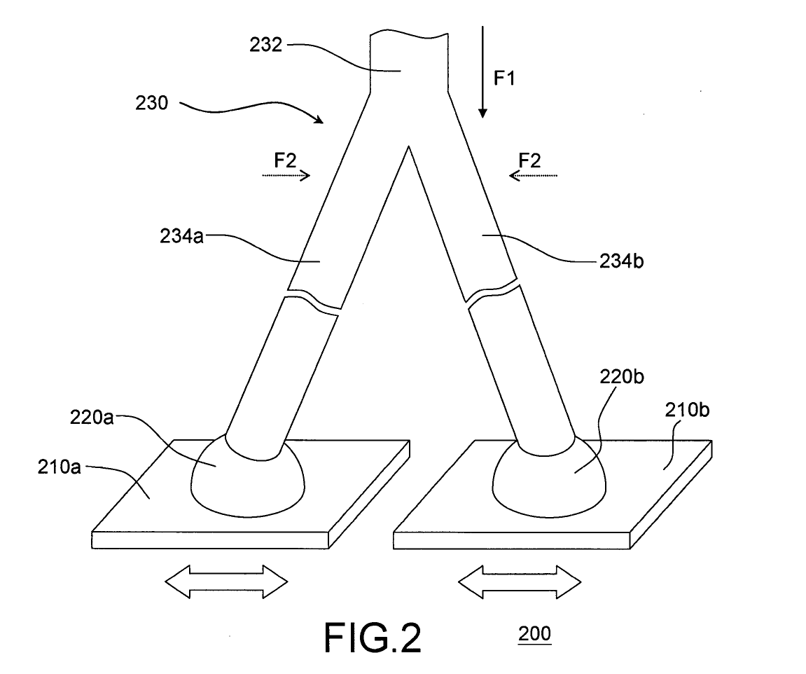

The capacitive stylus pen according to this invention could simulate user's two fingers for scaling up or down. Referring to FIG. 2, it is a schematic diagram of a capacitive stylus pen according to another embodiment of the present invention. The capacitive stylus pen 200 is similar with the pen 100 shown in FIG. 1A, but the capacitive stylus pen 200 has two conductive plate 210a, 210b and two joint 220a, 220b. The conductive pen body 230 includes a root 232 and two branches 234a, 234b. One end of the branch 234a, 234b is connected to the root 232, another end of the branch is connected to the joint 220a, 220b. The joints 220a, 220b are configured on the conductive plates 210a, 210b, respectively.

User usually puts one of the conductive plates 210a or 210b to stick on the touch panel to simulate the single finger of human. Alternatively, user puts the conductive plates 210a and 210b on the touch panel at the same time, holds the capacitive stylus pen 200 and gives a force F1 toward the touch panel, it would makes the conductive plates 210a, 210b far away to scale up a image file. Otherwise, user holds the capacitive stylus pen 200 and gives a force F2 backward the touch panel, it would makes the conductive plates 210a, 210b to be near to each other to scale down a image file.

In another embodiment, two universal joints could be configured between the root 232 and two branches 234a, 234b to use the capacitive stylus pen 200 smoothly.

Referring to FIG. 3, it is a perspective view of a capacitive stylus pen according to an embodiment of the present invention. In FIG. 3, the capacitive stylus pen 300 is similar with the capacitive stylus pen 100 shown in FIG. 1. But the capacitive stylus pen 300 only includes a conductive pen body 310 and a universal joint 320, the universal joint 320 connected with the conductive pen body 310 has a surface S. In this embodiment, the surface S of the universal joint 320 is similar with the minimum contact area of the conductive plate 110 which is stick on the touch panel 50 mentioned above. Also, the universal joint 320 is used to adjust the angel between the universal joint 320 and the touch panel 50 for user's writing. In other words, the universal joint 320 having the surface S is simplified other than the conductive plate and joint mentioned above, it makes cost lower and provides convenience to write or input for user.

Besides, the universal joint 320 could be constructed by a conductive material. For example, the material of surface of the universal joint 320 is, but not limited to, plastic or acrylic. Also, the surface S of the universal joint 320 could be constructed by a conductive material. The inner material of the universal joint 320 is a metal wire electrically coupled between the surface S and the conductive pen body 310.

As description above, the conductive pen body 310 could be designed two branches, the universal joint 320 also could be designed to have elasticity and the surface S of the universal joint 320 has a minimum contact area.

In conclusion, the capacitive stylus pen of the invention has the advantages as follow:

First, it provides convenience to write or input for user because the conductive joint is used to adjust the angle between the pen body and the touch panel when the conductive plate or universal joint stick on the touch panel.

Second, the capacitive stylus pen could be configured two or more conductive plates or universal joints for simulation of input like two or more fingers.

Third, the touch plane is fully touched on the surface because the conductive plate or universal joint is stick on the touch panel flatly. That reduces the dimension of the touch panel for mobile device and effectively determines touched position of the capacitive stylus pen.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A capacitive stylus pen, comprising:
a conductive pen body; and
at least one universal joint connected to the conductive pen body, wherein the universal joint has at least one quasi-flat surface.

2. The capacitive stylus pen as claimed in claim 1, wherein the conductive pen body comprises a root and two branches, wherein one end of the branch connected to the root and another end of the branch connected to the universal joint.

3. The capacitive stylus pen as claimed in claim 1 and 2, wherein the quasi-flat surface of the universal joint being configured to stick on a touch panel.

4. The capacitive stylus pen as claimed in claim 3, wherein the cross-section view of the quasi-flat surface of the universal joint is selected from the group consisting of a square, a circular form, a triangle form and a rhombus form.

5. The capacitive stylus pen as claimed in claim 3, wherein the square measure of the quasi-flat surface is larger than 1 mm².

6. The capacitive stylus pen as claimed in claim 1 and 2, wherein the conductive pen body is capable of having multiple dimensional motion on the universal joint to adjust an angle between the conductive pen and the touch panel.

7. The capacitive stylus pen as claimed in claim 1 and 2, wherein the universal joint has elasticity to keep vertical position between the universal joint and the touch panel when there is no external force involved.

8. The capacitive stylus pen as claimed in claim 2, wherein two branches is adapted to make two universal joints to be removed from or be near to, when there is external force involved.

9. A capacitive stylus pen, comprising:
at least one conductive plate;
at least one joint being configured on the conductive plate; and
a conductive pen body, wherein the joint is connected between the conductive plate and the conductive pen body such that the conductive pen body could move around the conductive plate.

10. The capacitive stylus pen as claimed in claim 9, wherein the conductive pen body comprises a root and two branches, wherein one end of the branch connected to the root and another end of the branch connected to the conductive plate.

11. The capacitive stylus pen as claimed in claim 9 and 10, wherein the conductive plate is adapted to stick on a touch panel.

12. The capacitive stylus pen as claimed in claim 9 and 10, wherein the shape of the conductive plate is selected from the group consisting of a square, a circular form, a triangle form and a rhombus form.

13. The capacitive stylus pen as claimed in claim 9 and 10, wherein the conductive pen body is capable of having multiple dimensional motion on the conductive plate to adjust an angle between the conductive pen and the touch panel.

14. The capacitive stylus pen as claimed in claim 9 and 10, wherein the joint is a universal joint, a universal drive joint, a flexible joint, or a cross joint.

15. The capacitive stylus pen as claimed in claim 9 and 10, wherein the joint has elasticity to keep vertical position between the conductive pen body and the touch panel when there is no external force involved.

16. The capacitive stylus pen as claimed in claim 9 and 10, wherein the square measure of the conductive plate is larger than 1 mm².

17. The capacitive stylus pen as claimed in claim 10, wherein two branches are adapted to make two universal joints to be removed from or be near to, when there is external force involved.
